(19) United States
(12) Patent Application Publication
(10) Pub. No.: US 2025/0112956 A1
(43) Pub. Date: Apr. 3, 2025

(54) METHODS FOR CREATING A HONEYPOT

(71) Applicant: Robert Bosch GmbH, Stuttgart (DE)

(72) Inventors: Christopher Huth, Heilbronn (DE); Dominik Germek, Berlin (DE); Niclas Ilg, Ammerbuch (DE)

(21) Appl. No.: 18/808,322

(22) Filed: Aug. 19, 2024

(30) Foreign Application Priority Data
Sep. 29, 2023 (DE) 10 2023 209 599.8

(51) Int. Cl. H04L 9/40

(52) U.S. Cl. CPC H04L 63/1491; H04L 63/168

(57) ABSTRACT

A method for creating a honeypot. The method includes sending requests to a target system; observing the responses of the target system to the requests; in accordance with the observed responses of the target system, creating a state machine model for the behavior of a network protocol according to which the target system responds to requests; and creating a honeypot that responds to requests in accordance with the state machine model.

### CROSS REFERENCE

The present application claims the benefit under 35 U.S.C. § 119 of German Patent Application No. DE 10 2023 209 599.8 filed on Sep. 29, 2023, which is expressly incorporated herein by reference in its entirety.

### FIELD

The present disclosure relates to methods for creating a honeypot.

### BACKGROUND INFORMATION

The number of networked data processing devices (including embedded devices) is increasing rapidly. One important aspect of all of these devices—be it server computers on the Internet or control devices in the automotive or the IoT sector—is product security. Honeypots are dummy sites that mimic such a high-value (target) system in order to lure attackers and gain information about their attack strategies and targets. Especially in corporate IT, honeypots are a well-established tool for threat analysis and are now also being used in the (Industrial) Internet of Things ((I)IoT). Altough honeypots are a very useful tool to supplement a cybersecurity strategy, the implementation of suitable honeypots for the specific need and the respective target system requires a lot of manual work by experts.

Approaches that make it easier to provide (in particular configure) a suitable honeypot are therefore desirable.

### SUMMARY

According to various embodiments, a method for creating a honeypot is provided which comprises:
sending requests to a target system (e.g. API calls, service calls, shell commands);
observing the responses of the target system to the requests;
in accordance with the observed responses of the target system, creating a state machine model for the behavior of a network protocol according to which the target system responds to requests (i.e. according to which it responds to requests from a communication partner with which it communicates via a network interface); and
creating a honeypot that responds to requests in accordance with the state machine model.

Thus, according to various embodiments of the present invention, a honeypot is created, for example automatically, by estimating a state machine for a target system (incl. target software), in particular a network protocol used by said target system. A state machine estimated in this way can then be used for an interactive honeypot. Porting and adapting such an estimated state machine to give the impression that a network protocol is implemented with a specific software version can thus be accomplished easily and automatically.

The above-described method makes it possible to improve the mimicking of services by a honeypot without manually inheriting the service characteristics, especially features of a network protocol used for the services. Therefore, a honeypot can be provided that seems realistic, for example without requiring manual implementation of a server for a network protocol (or service) that acts as a proxy. It is in particular possible for a honeypot to automatically adopt a new or updated version of a network protocol. A honeypot can thus not only mimic different versions of a service, but also different implementations of a service.

Various embodiment examples of the present invention are provided in the following.

Embodiment example 1 is a method for creating a honeypot, as described above.

Embodiment example 2 is the method according to embodiment example 1, in which the state machine model is created by adapting a previously created other state machine model for another (e.g. non-critical) target system in accordance with the observed responses of the target system.

This enables the state machine model to be created efficiently, in particular when honeypots are being created for different target systems.

Embodiment example 3 is the method according to embodiment example 2, in which the other state machine model is created by sending the requests and/or other requests to the other target system, observing the responses of the other target system to the requests or the other requests, and creating the other state machine model in accordance with the observed responses of the other target system.

Thus, according to one embodiment, the state machine is learned according to a two-stage procedure in which a state machine is first learned for a “base” target system (i.e. the “other” target system), which is then adapted for the actual target system. The state machine model for the base target system can be adapted for different target systems. It should be noted that, in the method generally described above, the “target system” can also refer to the base target system and creating a honeypot that responds to requests in accordance with the state machine model in this step also includes the step of adapting to the target system. If the actual target system (of the honeypot) and the base target system do not differ significantly (for example only version numbers or other information that is output is adapted), the honeypot then responds to requests in this interpretation “according to the state machine model” despite the adaptation-but it is then a honeypot for the actual target system and not for the base target system to which the requests were sent.

Embodiment example 4 is the method according to embodiment example 2 or 3, in which adapting the other state machine model includes adapting a version of the network protocol the behavior of which models the other state machine model in accordance with the responses observed.

The other state machine model may possibly only need to be changed slightly, for example by supplementing it with special features of the version of the network protocol used by the target system.

Embodiment example 5 is the method according to one of embodiment examples 2 to 4, in which the other state machine model is selected from a set of other state machine models for the other target system or one or more other target systems based on a check to see if the other state machine model fulfills the functions needed to mimic the target system.

Thus, on the one hand, the state machine model for the target system can be created efficiently and, on the other hand, it can be ensured that it is suitable for modeling the network protocol of the target system.

Embodiment example 6 is the method according to one of embodiment examples 1 to 5, in which the network protocol is an application layer network protocol.

Examples of this include Hypertext Transfer Protocol (HTTP) and Secure Shell (SSH). The honeypot can thus be created such that it behaves credibly on the application layer.

Embodiment example 7 is the method according to one of embodiment examples 1 to 6, in which information about the target system to be kept secret according to a confidentiality criterion is removed from the state machine model when the state machine model is created.

The state machine model can therefore be filtered in terms of information to be kept secret (such as passwords, but also operators of the honeypot), for example to avoid security problems for the target system (e.g. due to passwords that have become known).

Embodiment example 8 is a honeypot creating device configured to carry out the method according to one of embodiment examples 1 to 7.

Embodiment example 9 is a computer program comprising instructions that, when executed by a processor, cause said processor to carry out a method according to one of embodiment examples 1 to 7.

Embodiment example 10 is a computer-readable medium which stores instructions that, when executed by a processor, cause said processor to carry out a method according to one of embodiment examples 1 to 7.

In the figures, like reference signs generally refer to the same parts throughout the different views. The figures are not necessarily to scale, wherein emphasis is instead generally placed on representing the principles of the present invention. Various aspects are described in the following description with reference to the figures.

### BRIEF DESCRIPTION OF THE DRAWINGS

FIG. 1 shows a computer network, according to an example embodiment of the present invention.

FIG. 2 illustrates the learning of a state machine for a network protocol, according to an example embodiment of the present invention.

FIG. 3 shows an example of a learned state machine for a network protocol, according to the present invention.

FIG. 4 illustrates the creation of a honeypot according to one embodiment of the present invention.

FIG. 5 shows a flowchart that illustrates a method for creating a honeypot according to an example embodiment of the present invention.

### DETAILED DESCRIPTION OF EXAMPLE EMBODIMENTS

The following detailed description relates to the figures, which, for clarification, show specific details and aspects of this disclosure in which the present invention can be implemented. Other aspects can be used, and structural, logical, and electrical changes can be carried out without departing from the scope of protection of the present invention. The various aspects of this disclosure are not necessarily mutually exclusive since some aspects of this disclosure can be combined with one or more other aspects of this disclosure to form new aspects.

Different examples will be described in more detail in the following.

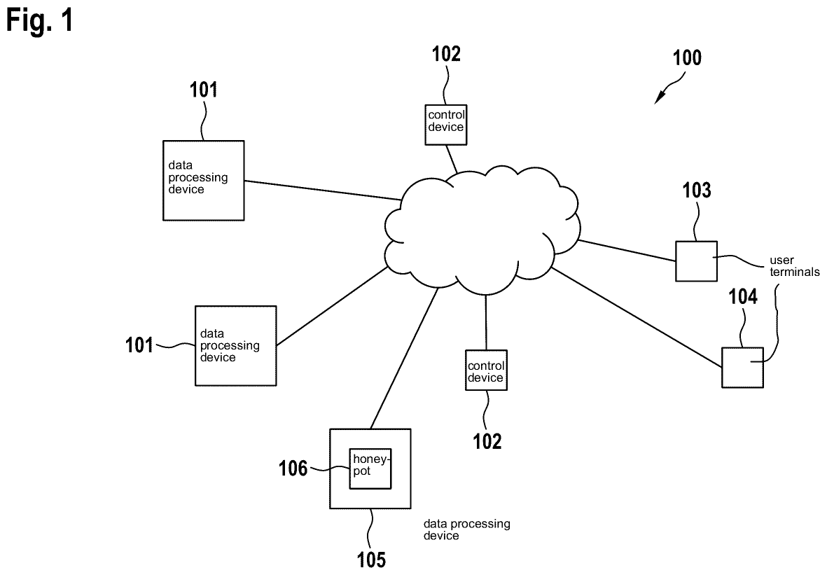

FIG. 1 shows a computer network 100. The computer network 100 includes a plurality of data processing devices 101-105 that are connected to one another by communication links. The data processing devices 101-105 include server computers 101 and control devices 102, for example, as well as user terminals 103, 104.

Server computers 101 provide a variety of services, such as Internet pages, banking portals, etc. A control device 102 is a control device for a robot device, for example, e.g. a control device in an autonomous vehicle. The server computers 101 and control devices 102 thus fulfill a variety of tasks and a server computer 101 or a control device 102 can typically be accessed from a user terminal 103, 104. This is the case in particular when a server computer 101 provides a functionality, such as a banking portal, to a user. However, a control device 102 can also enable access from the outside (e.g. in order for it to be able to be configured). Depending on the task of a server computer 101 or control device 102, it can store security-related data and carry out security-related tasks. It is therefore necessary to protect them from attackers. With a successful attack, for instance, an attacker using one of the user terminals 104 could gain possession of secret data (such as keys), manipulate accounts, or even manipulate a control device 102 in such a way that it causes an accident.

One security measure against such attacks is a so-called honeypot 106 (that id implemented by one of the data processing devices 105). It seemingly provides a functionality and thus serves as bait to lure potential attackers. It is isolated from secret information or critical functionality, however, so that attacks on it take place in a controlled environment and the risk of compromising the actual functionality is minimized. It consequently makes it possible to gain knowledge about attacks on a target system (e.g. one of the server computers 101 or one of the control devices 102), and thus the threat landscape, which can be responded to by implementing appropriate measures on the target system without such attacks endangering the target system.

A honeypot is therefore a deception system that mimics a target system (also referred to as a “high-value target”). It entices attackers to attack the honeypot and reveal attack vectors that target the real high-value target. A web server, for example, (or the web server software) is a popular option mimicked by a honeypot. Since web servers make up a large portion of the public Internet, it is important to continuously monitor threats that target them.

Honeypots are particularly interesting for the automotive industry, because there is hardly any data about real attacks. According to various embodiments, the honeypot 106 can therefore be implemented in a vehicle, for example. The computer network 100 can then at least partly include an internal network of the vehicle (but also a network that establishes connectivity to the vehicle from the outside, such as a cellular network).

Honeypots are only effective as long as there is no easy way for attackers to identify a potential attack target as a honeypot, however. Fingerprinting is one form of honeypot discovery that an attacker can carry out to make such Angreifer identification. Since the intent of most honeypots is to mimic a wide range of possible target systems, (to credibly mimic a target system) they have to also be able to ascertain the version of the network protocol that connects a respective target system to the public Internet. One example of such a network protocol (for communication of the honeypot to the outside, e.g. with other data processing devices 101, 102) is Secure Shell (SSH). Since no honeypot can implement all possible versions of SSH servers and most honeypots are implemented in a different programming language than real SSH servers, SSH libraries can be used that are manually adapted to the SSH messages that are used when an attacker connects.

In the case of SSH, for example, the SSH protocol version exchange message can be made configurable:
SSH-2.0-OpenSSH_7.4p1 Debian-10+deb9u7
mimics an SSH server for a Debian system, for example, while
SSH-2.0-OpenSSH_8.5 QNX_Secure_Shell
suggests an SSH server for a QNX operating system (e.g. in a handshake between client and server).

However, such superficial adaptations can easily be discovered by creating messages that are only one step further in the protocol handshake. Fingerprinting is moreover also possible for other network protocol applications. To counteract this form of honeypot discovery, a honeypot can be limited to mimicking only a specific version (which limits its use) and manually inheriting all protocol messages, or manually implementing a real SSH server that acts as a proxy for a honeypot (which is laborious and inefficient).

Therefore, according to various embodiments, an approach is provided that makes it possible to automatically adopt any implementations and versions of a network protocol for a honeypot implementation using learned state machines (i.e. automatically create the honeypot such that implements the network protocol according to the learned state machine).

In state machine learning or machine learning, the state machine of a program or software (i.e. the learning target) is typically not known, but can be learned by observing the resulting output with well-formulated inputs. State machine learning is divided into two dimensions: (1) activity and (2) visibility. In terms of activity, there are active and passive learning algorithms. Whereas passive algorithms learn only from observing the data traffic, e.g. from the recorded data traffic between a client and a server, active algorithms can make new queries, for example to the server, to discover even more states. To ensure visibility, learning algorithms operate in either a black-box, grey-box or white-box setting. In the white-box setting, everything within the software and code is visible to the algorithms. State machine learning can work with additional static analysis tools, for instance. In the black-box setting, it is only possible to create the messages to the learning target and observe the responses of the learning target without any knowledge of the software internals. In the gray-box environment, light weight instrumentation has typically been compiled into the learning target to obtain some additional coverage information during runtime and to facilitate state estimation.

Learning algorithms for state machines can create different models that represent the state machine for a target system. State machines can in general be deterministic and nondeterministic. A deterministic finite automaton (DFA) has deterministic behavior with respect to its state transitions, i.e. a target state depends only on the input symbols and its initial state. A nondeterministic finite automaton (NFA) does not follow the deterministic behavior of a DFA, i.e. state transitions in an NFA from an identical initial state with an identical input symbol can lead to a different state change. One of the best known algorithms for machine learning is the L* algorithm.

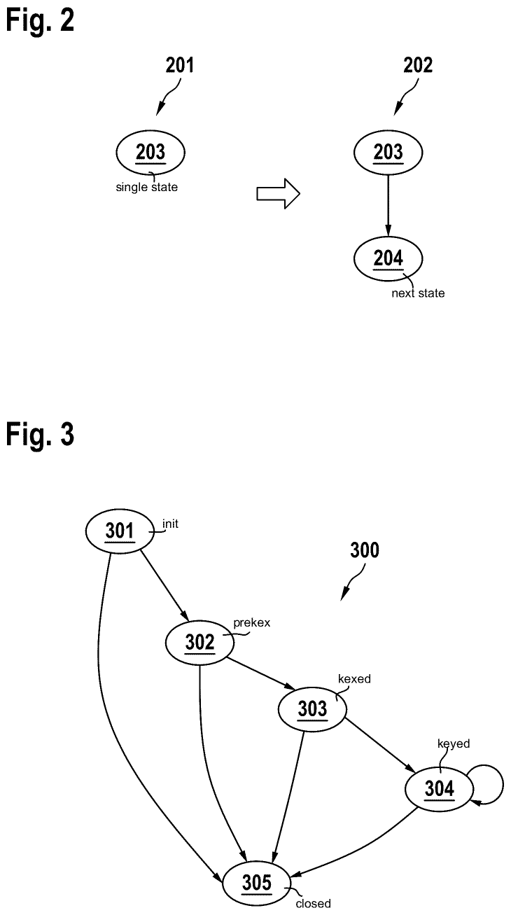

FIG. 2 illustrates the learning of a state machine for a network protocol.

The algorithm starts with a state machine 201 of a single state 203, e.g. “init” (or even an empty machine). When trying messages from the SSH protocol, a next state 204, e.g. “closed”, is discovered (typically quickly), so that the state machine is accordingly expanded to a state machine 202 having two states.

The algorithm continues to run in this way, is ultimately terminated and, as shown in FIG. 3, provides a state machine as the output.

FIG. 3 shows an example of a learned state machine 300 for a network protocol.

This comprises, for example,
a first state 301, e.g. “init”,
a second state 302, e.g. “prekex”
a third state 303, e.g. “kexed”
a fourth state 304, e.g. “keyed”, and
a fifth state 305, e.g. “closed”.

The state transitions are triggered as follows, for instance:
301 to 302: KEXINIT/KEXINIT, GUESSINIT/KEXINIT; SR AUTH/KEXINIT, KEX30/KEXINIT, SR_CONN/KEXINIT
302 to 303: KEX30/KEX31+NEWKEYS
303 to 304: NEWKEYS/NO_RESP
301 to 305: DISCONN/KEXINIT
302 to 305: DISCONN/NO_CONN, OTHER/DISCONN
303 to 305: DISCONN/NO_CONN, OTHER/DISCONN
304 to 302: DISCONN/NO CONN, SR CONN/DISCONN, NEWKEYS/NO_CONN
305 in itself: KEXINIT/UNIMPL, GUESSINIT/UNIMPL, SR_AUTH/ACCEPT, KEX30/UNIMPL

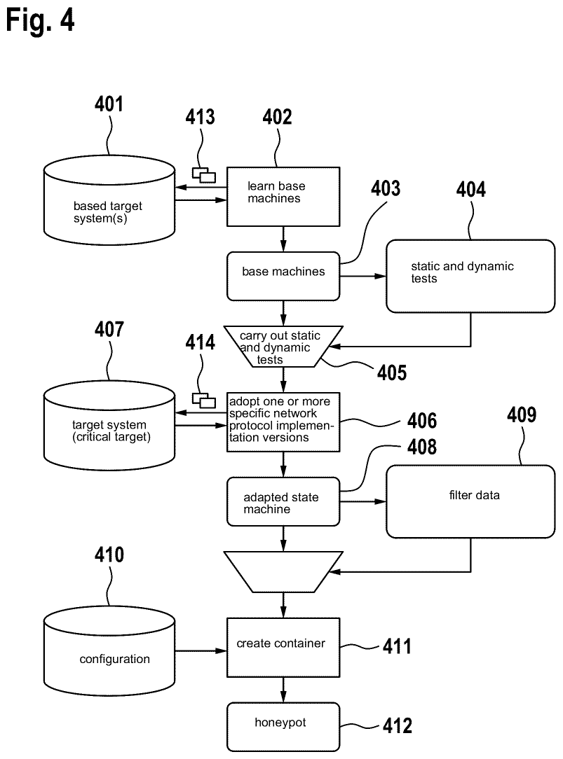

FIG. 4 illustrates the creation of a honeypot according to one embodiment.

A configuration of the honeypot (and possibly also the selection of an architecture for the honeypot being configured) is ascertained by a honeypot creating device (or honeypot configuration device), for example corresponding to one of the user terminals 104 (e.g. a computer, with which a user (such as a system administrator) configures the honeypot 106 and instructs the data processing device 105 to provide the thus configured honeypot 106). The methods described here for creating a honeypot are therefore carried out (for example automatically) by such a honeypot creating device, for instance.

First, in 402, base machines 403 for various protocol implementations of one or more non-critical target systems 401 are learned (e.g. by sending requests 413 to the one or more non-critical target systems (or “base” target systems) 401 and observing the responses to the requests). Since different versions of a protocol implementation are similar, this precompilation reduces the time needed for a later version adoption.

Once a base machine is derived, a series of static and dynamic tests 404 are carried out in 405 to verify that the base machine fulfills all required functions. Unnecessary states are also removed from the base machine in this step. This includes states that are present in only a few versions (during version adoption these are relearned more quickly for a few versions than for the majority of versions) or very deep and complex protocol implementations can be simplified (e.g. to comply with certain constraints such as execution time).

A suitable base machine is then used in 406 to adopt one or more specific network protocol implementation versions that are running on a respective target system 407 (also referred to as a “critical target”) to be mimicked by a honeypot. This target system 407 is probed (by sending requests 414, such as API (application programming interface) calls, service calls, shell commands, etc., to the target system 407—these can be the same or different requests as the requests 413 to the base target system(s)) (i.e. observing the responses of the target system 407 to the requests 414), and the machine adopts the states that correspond to the specific version of the respective network protocol of the target system. The result is an adapted state machine 408.

A simple HTTP example is inheriting header fields to include the correct service version: If a return header state in the base machine returns
Server: Apache/2.4
the state machine adapted for a target system running Ubuntu server would return
Server: Apache/2.4.29 (Ubuntu)
and
the state machine adapted to a target system running Windows would, for example, return
Server: Apache/2.4.33 (Win32).

Since the version adoption (i.e. the adaptation of the base machine to the target system in 406) probes an actual target system 407 that is later mimicked by the honeypot, meaningful data are filtered out of the adapted state machine 408 in 409 to prevent data leaks and reputational damage

The learning algorithm could find a state transition to successfully authorize itself in a login state, for instance. To prevent an attacker from being able to discover legitimate login data (e.g. by means of a brute-force attack), the adapted state machine 408 is set (i.e. modified during filtering 409) to randomly distribute login data, for instance.

Another example is that a system that is intentionally made vulnerable (i.e. in this case the honeypot) may typically not contain any references, for example to company names, as this could damage the reputation of the respective company. These can be removed during filtering.

A thus ascertained (in particular filtered) state machine can then be used to configure a honeypot 412 that mimics freely configurable network services (in terms of network protocol).

This is accomplished by ascertaining a suitable configuration 410, creating a container 411 with a corresponding honeypot software, and executing the honeypot software on a data processing device 105 in the computer network 100, for example.

The honeypot 412 is implemented in such a way that it uses the ascertained state machine to simulate a network protocol (e.g. for a service) (i.e. mimics the network protocol according to the ascertained state machine). States can alternatively also be copied into the one configuration of the honeypot 412. The honeypot 412 can then change states depending on the inputs of the attacker and/or other internal conditions, for example a time value for changing to a vulnerable state 10 minutes after being attacked.

The static and dynamic tests 404 and the filtering of sensitive data can also be carried out together in one step.

The static and dynamic tests 404 can also be omitted; but this can lead to an excessive number of created base machines (because none are removed using the tests and a learning algorithm is executed multiple times, for example, thus producing multiple base machines).

The step of filtering 409 is optional, too (if the risk of the honeypot containing sensitive data can be taken).

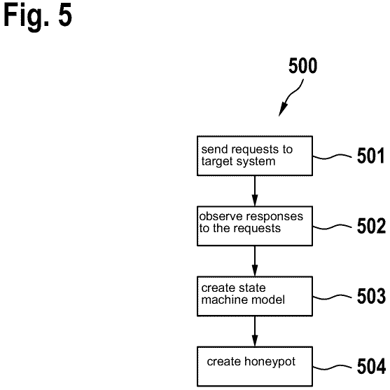

In summary, according to various embodiments, a method is provided as shown in FIG. 5.

FIG. 5 shows a flowchart 500 that illustrates a method for creating a honeypot according to an embodiment.

In 501, requests are sent to a target system (e.g. API calls, service calls, shell commands).

In 502, responses of the target system to the requests are observed.

In 503, a state machine model for the behavior of a network protocol according to which the target system responds to requests (i.e. according to which it responds to requests (or messages) of a communication partner with which it communicates via a network interface) is created in accordance with the observed responses of the target system.

In 504, a honeypot is created that responds to requests (i.e. operates or communicates, i.e. responds, in particular replies, to messages) according to the state machine model.

The method of FIG. 5 can be carried out by one or more computers comprising one or more data processing units. The term “data processing unit” can be understood to mean any type of entity that enables the processing of data or signals. The data or signals can, for example, be processed according to at least one (i.e. one or more than one) specific function carried out by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other way of implementing the respective functions described in more detail here can also be understood as a data processing unit or logic circuitry. One or more of the method steps described in detail here can be carried out (e.g. implemented) by a data processing unit by means of one or more specific functions executed by the data processing unit.

According to various embodiments, therefore, the method is in particular computer-implemented.

What is claimed is:

1. A method for creating a honeypot, comprising the following steps:
sending requests to a target system;
observing responses of the target system to the requests;
creating, in accordance with the observed responses of the target system, a state machine model for a behavior of a network protocol according to which the target system responds to requests; and
creating a honeypot that responds to requests in accordance with the state machine model.

2. The method according to claim 1, wherein the state machine model is created by adapting a previously created other state machine model for another target system in accordance with the observed responses of the target system.

3. The method according to claim 2, wherein the other state machine model is created by sending the requests and/or other requests to the other target system, observing responses of the other target system to the requests or the other requests, and creating the other state machine model in accordance with the observed responses of the other target system.

4. The method according to claim 2, wherein the adapting of the other state machine model includes adapting a version of the network protocol the behavior of which models the other state machine model in accordance with the observed responses of the target system.

5. The method according to claim 2, wherein the other state machine model is selected from a set of other state machine models for the other target system, or one or more other target systems, based on a check to see whether the other state machine model fulfills the functions needed to mimic the target system.

6. The method according to claim 1, wherein the network protocol is an application layer network protocol.

7. The method according to claim 1, wherein information about the target system to be kept secret according to a confidentiality criterion is removed from the state machine model when the state machine model is created.

8. A honeypot creating device, configured to create a honeypot, the honeypot being configured to:
send requests to a target system;
observe responses of the target system to the requests;
create, in accordance with the observed responses of the target system, a state machine model for a behavior of a network protocol according to which the target system responds to requests; and
create a honeypot that responds to requests in accordance with the state machine model.

9. A non-transitory computer-readable medium on which is stored instructions for creating a honeypot, the instructions, when executed by a processor, causing the processor to perform the following steps:
sending requests to a target system;
observing responses of the target system to the requests;
creating, in accordance with the observed responses of the target system, a state machine model for a behavior of a network protocol according to which the target system responds to requests; and
creating a honeypot that responds to requests in accordance with the state machine model.
